(19) United States
(12) Patent Application Publication
(10) Pub. No.: US 2026/0288522 A1
(43) Pub. Date: Sep. 24, 2026

(54) System and method for executing tasks using multi-modal task-specific mini-systems

(71) Applicant: Bank of America Corporation, Charlotte, NC (US)

(72) Inventors: Jemlin Lucas, Coppell, TX (US); Suryanarayana Adivi, Hyderabad (IN); Pushkar Taneja, Hyderabad (IN)

(21) Appl. No.: 19/082,554

(22) Filed: Mar. 18, 2025

(51) Int. Cl. G06F 9/50

(52) U.S. Cl. CPC G06F 9/5027

(57) ABSTRACT

A system includes a memory storing a generative AI model and task-specific AI models and processors coupled to the memory. The processors receive a multi-modal input including a first input in a first modality and a second input in a second modality and execute the generative AI model on the multi-modal input to determine a task. The processors execute a first and a second task-specific AI models on the first and second inputs respectively to extract first and second respective features. The processors extract a first subset of first features and a second subset of second features by the generative AI model, generate a unified multi-modal feature representation integrating the first subset of first features and the second subset of second features by the generative AI model, and execute the generative AI model on the unified multi-modal feature representation to output an execution result for the task.

### TECHNICAL FIELD

The present disclosure relates generally to executing tasks, and more specifically, to executing tasks using multi-modal task-specific mini-systems.

### BACKGROUND

Building an artificial intelligence (AI) model involves defining a problem, preparing data, selecting an algorithm, training the model, and deploying the model. AI models are computer programs that use algorithms to analyze data, make decisions, and provide solutions. The trend in AI (e.g., machine learning) is to build larger, more complex models with many parameters, capable of learning and representing more complicated patterns and relationships in the data.

### SUMMARY

Conventional systems use large and complex AI models to analyze data and execute tasks accordingly. Large and complex AI models require massive amounts of data, computational resources, and time to train. Requiring enormous amount of data for training can introduce noisy, imbalanced, incomplete, or low-quality data that may not be resolved due to the massive amount. Training AI models using such data results in lower accuracy, which will generalize poorly and fail in real-world tasks. Requiring enormous amount of computational resources for training can also result in lower model accuracy and stability as whenever computational resources do not meet the requirement, model training may force the use of lower precision calculations or reduced batch sizes. Requiring a massive amount of time for training can result in outdated models in rapidly changing systems. Using AI models with lower accuracy and stability or being outdated to analyze data and execute tasks can result in adverse execution results. When downstream systems rely on execution results from AI models, adverse execution results can further cause downstream systems to fail.

The system disclosed in the present application provides a technical solution to the problems discussed above. The disclosed system develops and utilizes small and specialized AI models, particularly in multi-modal data analysis and task executions. The disclosed system uses mini-systems executing task-specific AI models to analyze and process inputs for different tasks. Each task-specific AI model is trained for a specific task and is isolated from each other for improved security. Training task-specific AI models requires a small amount of data, fewer computational resources, and is also faster. When receiving a user or system input, a generative AI model determines which mini-system(s) to use and calls the corresponding mini-system(s) to process the input by executing their task-specific AI models. Multiple mini-systems may be used, and the results will be integrated for further analysis. For example, the analysis may include detecting prohibited interactions based on the input.

In one embodiment, the disclosed system includes a memory operable to store a generative artificial-intelligence (AI) model and a plurality of task-specific AI models. Each of the task-specific AI models was trained to process inputs in a particular modality for a particular task. The disclosed system further includes one or more processors operably coupled to the memory. The processors are configured to receive a multi-modal input combining a plurality of different types of data. The multi-modal input includes at least a first input in a first modality corresponding to a first type of data and a second input in a second modality corresponding to a second type of data. The processors are further configured to execute the generative AI model on the multi-modal input to determine a task associated with the multi-modal input. The processors are further configured to load, based at least in part upon the task and the multi-modal input by the generative AI model, a first task-specific AI model from the plurality of task-specific AI models to process the first input. The processors are further configured to load, based at least in part upon the task and the multi-modal input by the generative AI model, a second task-specific AI model from the plurality of task-specific AI models to process the second input. The first task-specific AI model is configured to process the first input and the second task-specific AI model is configured to process the second input independently of each other. The processors are further configured to execute the first task-specific AI model on the first input to extract a plurality of first features of the first input. The processors are further configured to execute the second task-specific AI model on the second input to extract a plurality of second features of the second input. The processors are further configured to extract, by the generative AI model, a first subset of first features from the plurality of first features. The processors are further configured to extract, by the generative AI model, a second subset of second features from the plurality of second features. The processors are further configured to generate, based at least in part upon the first subset of first features and the second subset of second feature by the generative AI model, a unified multi-modal feature representation for the multi-modal input. The unified multi-modal feature integrates the first subset of first features and the second subset of second features. The processors are further configured to execute the generative AI model on the unified multi-modal feature representation to output an execution result for the task.

In one embodiment, the generative AI model is executed by a first processor of the one or more processors. The first task-specific AI model is executed by a second processor of the one or more processors. The second task-specific AI model is executed by a third processor of the one or more processors. At least two of the first, second, and third processors are different processors.

In one embodiment, the generative AI model, the first task-specific AI model, and the second task-specific AI model are executed by one or more same processors of the one or more processors.

In one embodiment, the multi-modal input is associated with a first interaction and the task includes detecting whether the first interaction is a prohibited interaction. Accordingly, executing the generative AI model on the unified multi-modal feature representation to output the execution result for the task includes executing the generative AI model on the unified multi-modal feature representation to output a probability score indicating a likelihood of the first interaction being a prohibited interaction. Executing the generative AI model on the unified multi-modal feature representation to output the execution result for the task further includes declining the first interaction if the probability score is greater than a threshold score, for which the execution result for the task includes a declination of the first interaction. Executing the generative AI model on the unified multi-modal feature representation to output the execution result for the task further includes approving the first interaction if the probability score is not greater than the threshold score, for which the execution result for the task includes an approval of the first interaction.

In one embodiment, the processors are further configured to execute a third task-specific AI model from the plurality of task-specific models to extract interaction metadata associated with the interaction. The interaction metadata includes one or more of a location associated with the first interaction, an IP address associated with the first interaction, a time associated with the first interaction, or a type associated with the first interaction. The processors are further configured to integrate the interaction metadata into the unified multi-modal feature representation for the multi-modal input.

In one embodiment, the first input includes a text string or a speech. The processors are further configured to perform pattern mining on the first input using the first task-specific AI model to uncover one or more patterns comprising one or more of a language pattern, an inconsistency, a depth of understanding, a response timing, an error pattern, an interaction pattern, or a factual inaccuracy. Extracting the plurality of first features from the first input is based on the uncovered patterns.

In one embodiment, the second input includes a video. The processors are further configured to perform pattern mining on the second input using the second task-specific AI model to uncover one or more patterns comprising one or more of an inconsistent facial expression, an inconsistent lip sync, a lack of natural interaction, an unusual background or environment, an inconsistent behavior, a repetitive behavior, a technical artifact, or a quality issue. Extracting the plurality of second features from the second input is based on the uncovered patterns.

The disclosed system and methods provide the practical application of using small and specialized task-specific AI models to analyze multi-modal input and execute tasks efficiently. Conventional systems use large and complex AI models to analyze data and execute tasks accordingly. Large and complex AI models require massive amounts of data, computational resources, and time to train. Requiring enormous amount of data, computational resources, and time for training can result in lower model accuracy and stability, or outdated models, which can further cause downstream systems to fail. The disclosed system and methods can address such problems using small and specialized task-specific AI models to efficiently analyze multi-modal input and execute tasks. As described in example embodiments of the present disclosure, the disclosed system and methods use a generative AI model to analyze a multi-modal input to identify task-specific AI models, executing the identified task-specific AI models on the multi-modal input to extract features corresponding to different modalities, use the generative AI model to select most relevant features from the extracted features, integrate the selected features corresponding to different modalities into a unified feature representation, and execute the generative AI model on the unified feature representation to output an execution result. Executing small and specialized task-specific AI models on the multi-modal input to extract features corresponding to different modalities requires fewer computational resources. Each task-specific AI model has fewer model parameters to reduce memory and CPU consumption. In addition, small and specialized task-specific AI models execute faster as they perform fewer computations. Furthermore, training small and specialized task-specific AI models is efficient as they require less training data (i.e., training each task-specific AI model only requires task-specific data) and less training time (i.e., training converges faster). As described in example embodiments of the present disclosure, the disclosed system and methods use different processors to execute task-specific AI models to extract features for multiple modalities concurrently, speeding up the execution of entire feature extraction compared to conventional feature extraction where a single processor may extract features for different modalities sequentially. In addition, when executing task-specific AI models, the disclosed system and methods can balance workload across these different processors to increase the utilization of each processor.

Technical advantages of certain embodiments of this disclosure may include one or more of the following. The disclosed system and methods can efficiently utilize the available computational resources by using small and specialized task-specific AI models. For example, training small and specialized task-specific AI models require less training data (i.e., training each task-specific AI model only requires task-specific data) and less training time (i.e., training converges faster), which means less memory is needed to store the training data. CPU is utilized for a shorter amount of time. As another example, each task-specific AI model has fewer model parameters and performs fewer computations, requiring less memory and CPU during the execution. The disclosed system and methods can improve system stability by using small and specialized task-specific AI models. For example, training small and specialized task-specific AI models requires a small amount of training data, which can ensure high-quality training data is used. Training task-specific AI models using high-quality data results in high model accuracy, which will generalize well and succeed in real-world tasks. As another example, it is easy to have a sufficient amount of computational resources to train small and specialized task-specific AI models, which can guarantee model accuracy and stability (e.g., model training does not force the use of lower precision calculations or reduced batch sizes when enough computational resources are available). As another example, small and specialized task-specific AI models are easier to retrain and update without extensive retraining, which can effectively manage tasks in rapidly changing systems. Using AI models with high accuracy, stability, and rapid adaptability to analyze data and execute tasks can result in reliable execution results, which further ensures the stability of downstream systems that rely on execution results from the AI models. By executing task-specific AI models concurrently on different processors, the disclosed system and methods can speed up the entire task execution. For example, other processors can execute different task-specific AI models to analyze different modalities of data concurrently, which is more efficient than using the same processor(s) to analyze all modalities of data sequentially.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates one embodiment of a system that is configured for executing tasks using multi-modal task-specific mini-systems.

FIGS. 2A-2B illustrate an example flowchart of a method for executing tasks using multi-modal task-specific mini-systems.

### DETAILED DESCRIPTION

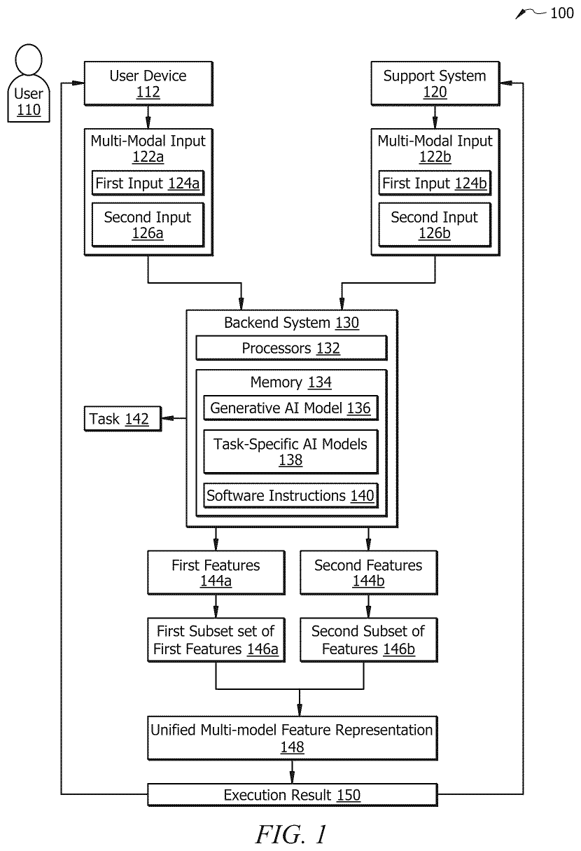

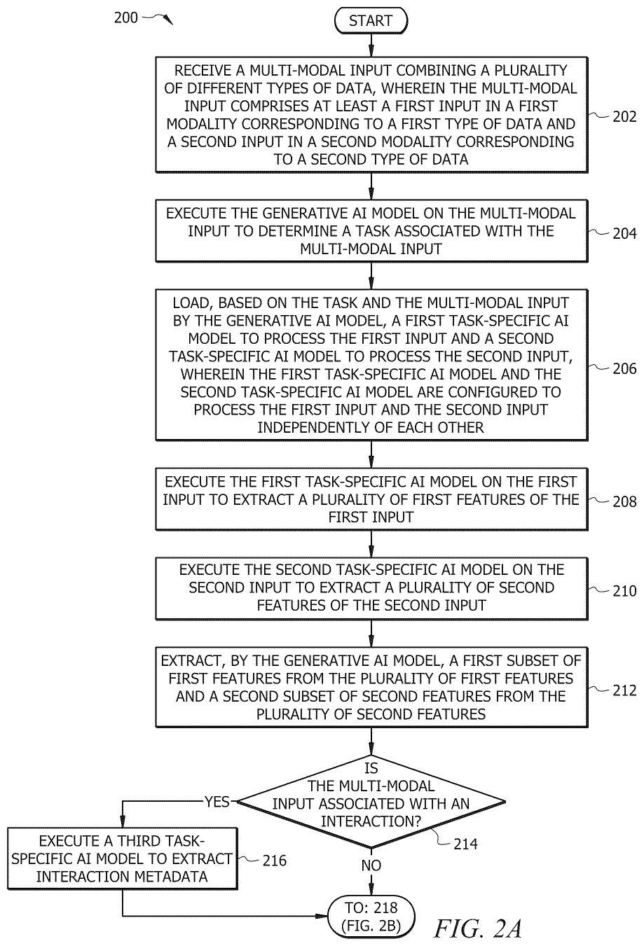

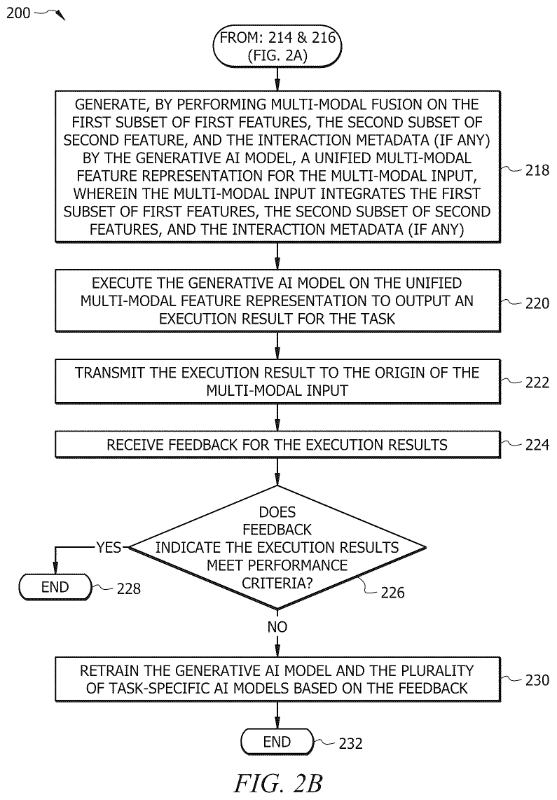

As described above, conventional systems may build more extensive and more complex AI models, which require massive amounts of data, computational resources, and time to train. This disclosure provides various systems and methods to utilize smaller, more specialized AI models, particularly in the context of multi-modal frameworks, which improves the utilization of computing resources and security. FIG. 1 illustrates one embodiment of a system that is configured for executing tasks using multi-modal task-specific mini-systems. FIGS. 2A-2B illustrate an example flowchart of a method for executing tasks using multi-modal task-specific mini-systems.

### Example System for Executing Tasks Using Multi-Modal Task-Specific Mini-Systems

FIG. 1 illustrates one embodiment of a system 100 that is configured for executing tasks using multi-modal task-specific mini-systems. System 100 comprises a user device 112 associated with a user 110, a support system 120, and a backend system 130. In some embodiments, system 100 may not have all of the components listed and/or may have other elements instead of, or in addition to, those listed above.

### Architecture Components

### User Device

Examples of user device 112 include, but are not limited to, computers, laptops, mobile devices (e.g., smart phones or tablets), servers, clients, or any other suitable type of device associated with user 110. User device 112 is generally configured to capture data and send instructions for processing the data to backend system 130. For example, the instructions from user device 112 to backend system 130 may comprise a multi-modal input 122a, requesting backend system 130 to provide a response. As another example, the data to user device 112 from user 110 may comprise a speech. As yet another example, the data to user device 112 from backend system 130 may include execution result 150. In other examples, the data may comprise any suitable type of data. The instructions may comprise any suitable type or number of commands for processing the data.

### Support System

Support system 120 is generally any device that is configured to process data and communicate with devices, systems (e.g., backend system 130), etc. Support system 120 is generally configured to execute supporting tasks based on data associated with these tasks. For example, the data may include metadata associated with interactions and the supporting task may be detecting and preventing prohibited interactions. To execute supporting tasks, support system 120 may transmit data to backend system 130 and receive responses from backend system 130. For example, the data may include a multi-modal input 122b and the response may include execution result 150.

### Backend System

Backend system 130 is generally any device that is configured to process data and communicate with devices (e.g., user device 112), systems (e.g., support system 120), etc. Backend system 130 is generally configured to perform operations described further below in conjunction with method 200 described in FIGS. 2A-2B. In an embodiment, backend system 130 comprises one or more processors 132 in signal communication with a memory 134.

Processors 132 are operably coupled to the memory 134. A processor 132 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). A processor 132 may be a programmable logic device, a microcontroller, a microprocessor, or any suitable combination of the preceding. Processors 132 are communicatively coupled to and in signal communication with memory 134. Processors 132 are configured to process data. For example, a processor 132 may be 8-bit, 16-bit, 32-bit, 64-bit or of any other suitable architecture. A processor 132 may include an arithmetic logic unit (ALU) for performing arithmetic and logic operations, processors register that supply operands to the ALU and store the results of ALU operations, and a control unit that fetches software instructions 140 from memory 134 and execute them by directing the coordinated operations of the ALU, registers and other components. Processors 132 are configured to implement various software instructions 140. For example, processors 132 are configured to execute software instructions 140 to implement the functions disclosed herein, such as some or all of those described with respect to FIGS. 1-2. In some embodiments, the function described herein is implemented using logic units, FPGAs, ASICs, DSPs, or any other suitable hardware or electronic circuitry.

Memory 134 may be volatile or non-volatile and may comprise a read-only memory (ROM), random-access memory (RAM), ternary content-addressable memory (TCAM), dynamic random-access memory (DRAM), and static random-access memory (SRAM). Memory 134 may be implemented using one or more disks, tape drives, solid-state drives, and/or the like. Memory 134 is operable to store the software (e.g., generative AI model 136 and task-specific AI models 138), and/or any other data or software instructions 140.

Generative AI model 136 and task-specific AI models 138 can be trained on a training dataset comprising a plurality of training data using appropriate algorithms. The training data may be of different types, such as text, image, video, and speech. The training data may be labeled as different task categories. To generate the training data, backend system 130 may collect historical interaction data, user interaction logs, and user feedback. Backend system 130 may annotate the collected data. For example, interaction data may be annotated as “prohibited” or “allowed.” Backend system 130 may preprocess the collected data. For example, backend system 130 may clean interaction records, remove duplicates, and format the collected data for analysis. As another example, backend system 130 may perform text cleaning, image resizing, speech-to-text conversion (i.e., voice commands from users are converted to text for analysis), etc.

Once the training data are generated, backend system 130 may split the training data. For example, the historical interaction data may be split into training, validation, and test sets. Based on the split datasets, backend system 130 can train generative AI model 136 for determining which task-specific AI model(s) 138 to use, determining which features are most relevant, and what decisions should be made with respect to the tasks 142, etc.

Based on the split datasets, backend system 130 can train each task-specific AI model 138 to analyze patterns of inputs in a particular modality and extract features accordingly. Each task-specific AI model 138 may be trained on training data in a particular modality for a particular task 142 using appropriate algorithms. For example, a first task-specific AI model 138a may be trained using training data including images associated with prohibited interaction detections. As another example, a second task-specific AI model 138b may be trained using training data including text associated with prohibited interaction detections. As yet another example, a third task-specific AI model 138c may be trained using training data including images associated with profile management. In an embodiment, task-specific AI models 138 may be machine-learning models.

Backend system 130 may use an optimization algorithm (e.g., Adam optimizer) to train generative AI model 136 or task-specific AI models 138. During the training, backend system 130 may perform model hyperparameter adjustment based on their performance on validation sets, in which iterative adjustments are made to learning rates and batch sizes.

In an embodiment, backend system 130 may utilize pre-trained models or transfer learning for initial weights associated with generative AI model 136 or task-specific AI models 138. This approach can enable faster convergence during training, thereby reducing training time. This approach can additionally improve performance by building upon previously learned patterns and features from the pre-trained models or transfer learning.

Backend system 130 may perform performance assessment before deploying generative AI model 136 or task-specific AI models 138 in real-world tasks 142. For example, backend system 130 may evaluate the ability of generative AI model 136 or task-specific AI models 138 to identify prohibited interactions using metrics like precision, recall, and F1-score. Results may be compared with conventional rule-based systems to ensure generative AI model 136 or task-specific AI models 138 provide significant improvements.

In an embodiment, backend system 130 may instruct generative AI model 136 to integrate task-specific AI models 138 into one or more applications associated with backend system 130. Backend system 130 may utilize generative AI model 136 to configure task-specific AI models 138 to process data in real-time or near-real-time, depending on an application's requirements.

When being executed by processors 132, task-specific AI models 138 can be viewed as mini-systems as each of the task-specific AI models 138 requires fewer computing resources. In an embodiment, generative AI model 136 and task-specific AI models 138 may be executed by the same processors 132. In another embodiment, generative AI model 136 and task-specific AI models 138 may be executed by different processors 132. In another embodiment, among task-specific AI models 138, at least two of the task-specific AI models 138 may be executed by different processors 132. In yet another embodiment, generative AI model 136 and some of the task-specific AI models 138 may be executed by the same processors 132 while the other task-specific AI models 138 may be executed by other processors 132.

Software instructions 140 may comprise any suitable set of instructions, logic, rules, or code operable to execute processors 132. Software instructions 140, when executed by processors 132, cause processors 132 to perform one or more functions described herein. For example, when software instructions 140 are executed, processors 132 execute generative AI model 136 to analyze multi-modal input 122 to load one or more of the task-specific AI model(s) 138 to use. When software instructions 140 are executed, processors 132 further execute the loaded task-specific AI model(s) 138 to extract features for multi-modal input 122. When software instructions 140 are executed, processors 132 further execute generative AI model 136 to extract most relevant features from the features extracted by the task-specific AI model(s) 138 and generate an integrated feature representation. When software instructions 140 are executed, processors 132 further execute generative AI model 136 to perform decision-making for the task 142 associated with multi-modal input 122.

### Operational Flow

In an embodiment, user device 112 may send multi-modal input 122a to backend system 130 (e.g., when user 110 requests profile management). In another embodiment, support system 120 may send multi-modal input 122b to backend system 130 (e.g., when support system 120 needs to detect prohibited interactions or assess risks). Multi-modal input 122 may combine different types of data and include at least a first input 124 and a second input 126. The first input 124 is in a first modality corresponding to a first type of data and the second input 126 is in a second modality corresponding to a second type of data. Although this disclosure describes two inputs in multi-modal input 122, this disclosure contemplates any suitable number (e.g., more than two) of inputs in multi-modal input 122. As an example, and not by way of limitation, multi-modal input 122 may include an email, a text, an image, a video, or an audio (e.g., corresponding to user's 110 speech).

When backend system 130 receives multi-modal input 122, backend system 130 may execute generative AI model 136 on multi-modal input 122 to determine a task 142 associated with multi-modal input 122. Task 142 may have defined objectives and requirements. Backend system 130 may execute generative AI model 136 to further design a small-scale model architecture that can efficiently process multi-modal input 122 and perform the task 142. Specifically, designing the small-scale model architecture may include determining which task-specific AI model(s) 138 should be loaded to process multi-modal input 122. Considering multi-modal input 122 includes a first input 124 and a second input 126, a first task-specific AI model 138a may be loaded to process the first input 124 while a second task-specific AI model 138b may be loaded to process the second input 126. For example, if the first input 124 is an email, the first task-specific AI model 138a may be a machine-learning model trained to process emails; if the second input 126 is a video, the second task-specific AI model 138b may be a machine-learning model trained to process videos. If multi-modal input 122 includes additional inputs in additional modalities corresponding to other types of data, backend system 130 may load more task-specific AI models 138 to process these inputs.

In an embodiment, backend system 130 may execute generative AI model 136 to preprocess data of multi-modal input 122, e.g., the first input 124 and the second input 126. For example, preprocessing may include text cleaning, image resizing, speech-to-text conversion, etc.

The first task-specific AI model 138a may extract first features 144a from the first input 124. The second task-specific AI model 138b may extract second features 144b from the second input 126. For example, features such TF-IDF may be extracted for text and convolutional neural network-based features may be extracted for images.

In an embodiment, backend system 130 may execute task-specific AI models 138 to perform pattern mining on inputs in multi-modal input 122. If the inputs are text or speech, pattern mining may uncover patterns including language patterns, inconsistencies, depth of understanding, response timing, error patterns, interaction patterns, or factual inaccuracies. For example, language patterns may include repetitive phrasing, overly formal language, lack of personal touch, etc. ; response timing may include speed of replies, consistent timing, etc. ; interaction patterns may include engagement in conversation, emotional responses, robotic-sounding voices, etc.

Take the task 142 of identifying whether a chat message or email is generated by an AI system or written by an actual user as an example. Regarding repetitive phrasing in language patterns, AI-generated text may exhibit repetitive phrases or structures. Regarding overly formal language in language patterns, AI may use more formal or structured language compared to casual human communication. Regarding lack of personal touch in language patterns, AI may lack personal anecdotes, emotions, or unique expressions that are common in human writing. regarding inconsistencies in contextual awareness, AI may struggle with maintaining context over long conversations or might provide answers that are contextually inappropriate. Regarding depth of understanding in contextual awareness, human responses often reflect deeper understanding or nuanced opinions, which can be hard for AI to replicate accurately. Regarding speed of replies in response timing, AI can generate responses almost instantaneously, while humans typically take longer, especially for thoughtful replies. Regarding consistent timing response timing, if responses are consistently quick and uniform without variation, it may indicate AI usage. Regarding complexity and originality in content analysis, AI may generate content that is either overly simplistic or lacks originality. Regarding error patterns in content analysis, AI-generated text may contain unusual or rare errors that are not typical of human writing. Regarding email headers in metadata and technical indicators, in emails, examining headers can sometimes reveal the source of the message. Regarding text analysis tools in metadata and technical indicators, there are specific tools and algorithms designed to analyze text and predict whether it was generated by AI or a human. Regarding engagement in conversation in interaction patterns, humans often ask follow-up questions or engage in small talk, while AI may focus strictly on the topic at hand. Regarding emotional responses in interaction patterns, humans typically express emotions, humor, or empathy, which may be less evident in AI-generated text. Regarding factual inaccuracies in use of common knowledge, AI may generate incorrect or outdated information, while a human might provide more current and accurate insights based on personal experience or knowledge.

If the inputs are videos, pattern mining may uncover patterns including inconsistent facial expressions, inconsistent lip synchronizations, lack of natural interactions, unusual background or environment, inconsistent behaviors, repetitive behaviors, technical artifacts, and quality issues (e.g., unnatural transitions, blurriness, or pixelation, etc.). Extracting the features from the inputs may be based on the uncovered patterns.

Backend system 130 may execute generative AI model 136 to select the most relevant features from the features extracted by each of the task-specific AI models 138. In other words, generative AI model 136 may extract the most relevant features for each modality. The most relevant features from different modalities are further combined into a unified multi-modal feature representation 148 using techniques like concatenation, attention mechanisms, or fusion layers. In an embodiment, backend system 130 may utilize attention mechanisms to assign more weights to more critical features when integrating them into the unified multi-modal feature representation 148.

In an embodiment, multi-modal input 122 may be associated with an interaction. Backend system 130 may execute another task-specific AI model 138c different from the first task-specific AI model 138a and the second task-specific AI model 138b to extract interaction metadata associated with the interaction. For example, the interaction metadata may include one or more of a location associated with the interaction, an IP address associated with the interaction, a time associated with the interaction, or an interaction type. Backend system 130 may further integrate the interaction metadata into the unified multi-modal feature representation 148 for multimodal input 122.

Integrating information from various sources (i.e., modalities) can improve contextual understanding and decision-making capabilities. For instance, combining interaction metadata with user behavior patterns (e.g., an interaction occurred in a location that the user has never visited before) and voice interactions (e.g., a voice command that expressed surprise or confusion about the interaction) can enable backend system 130 to detect nuances that may indicate prohibited interactions more effectively.

Once the unified multi-modal feature representation 148 is generated, backend system 130 may execute generative AI model 136 on the unified multi-modal feature representation 148 to output an execution result 150 for the task 142. The execution result 150 may include decision made regarding the task 142 or a prediction associated with the task 142. For example, the execution result 150 may be the determination of whether a chat message, email, audio, or video is generated by an AI system or by an actual user. As another example, the execution result 150 may be whether an interaction is a prohibited interaction. In an embodiment, if the interaction is prohibited, backend system 130 may decline the interaction; if the interaction is not prohibited, backend system 130 may approve the interaction.

Backend system 130 may transmit the execution result 150 to the origin of multi-modal input 122, e.g., user device 112 or support system 120. In an embodiment, support system 120 may perform actions responsive to the received execution result 150. Continue with the previous example of whether an interaction is a prohibited interaction. If the interaction is prohibited, support system 120 may decline the interaction. If the interaction is not prohibited, support system 120 may approve the interaction.

To ensure continuous improvement, backend system 130 may collect feedback from users 110 or support system 120 and monitor performance in real-world tasks 142. Periodic updates and retraining of generative AI model 136 or task-specific AI models 138 may be conducted with new data to maintain and enhance their performance.

### Example Methods for Executing Tasks Using Multi-Modal Task-Specific Mini-Systems

FIGS. 2A-2B illustrate an example flowchart of a method 200 for executing tasks using multi-modal task-specific mini-systems. Modifications, additions, or omissions may be made to method 200. Method 200 may include more, fewer, or other operations. For example, operations may be performed in parallel or in any suitable order. While at times discussed as backend system 130, or components of any of thereof performing operations, any suitable system or components of the system may perform one or more operations of the method 200. For example, one or more operations of method 200 may be implemented, at least in part, in the form of software instructions (e.g., software instructions 140 of FIG. 1), stored on non-transitory, tangible, machine-readable media (e.g., memory 134 of FIG. 1) that when run by one or more processors (e.g., processors 132 of FIG. 1) may cause the one or more processors to perform operations 202-232.

After start, backend system 106 receives a multi-modal input 122 combining a plurality of different types of data. The multi-modal input 122 may be received from user device 112 or support system 120. The multi-modal input 122 includes at least a first input 124 in a first modality corresponding to a first type of data and a second input 126 in a second modality corresponding to a second type of data.

At operation 204, backend system 130 executes the generative AI model 136 on the multi-modal input 122 to determine a task 142 associated with the multi-modal input 122. Generative AI model 136 was trained to determine which task-specific AI model(s) 138 to use, determine which features are most relevant, and what decisions should be made with respect to the tasks 142, etc.

At operation 206, backend system 130 loads, based on the task 142 and the multi-modal input 122 by the generative AI model 136, a first task-specific AI model 138a to process the first input 124 and a second task-specific AI model 138b to process the second input 126. Each task-specific AI model 138 was trained to analyze patterns of inputs in a particular modality and extract features accordingly. The first task-specific AI model 138a and the second task-specific AI model 138b are configured to process the first input 124 and the second input 126 independently of each other. For example, if the first input 124 is an email, the first task-specific AI model 138a may be a machine-learning model trained to process emails; if the second input 126 is a video, the second task-specific AI model 138b may be a machine-learning model trained to process videos. If the multi-modal input 122 includes additional inputs in additional modalities corresponding to other types of data, backend system 130 may load more task-specific AI models 138 to process these inputs.

At operation 208, backend system 130 executes the first task-specific AI model 138a on the first input 124 to extract a plurality of first features 144a of the first input 124. In an embodiment, the first input 124 includes a text string or a speech. The first task-specific AI model 138a performs pattern mining on the first input 124 to uncover patterns associated with the first input 124. For example, the patterns may include language patterns, inconsistencies, depths of understanding, response timing, error patterns, interaction patterns, or factual inaccuracies. Extracting the first features 144a from the first input 124 is based on the uncovered patterns.

At operation 210, backend system 130 executes the second task-specific AI model 138b on the second input 126 to extract a plurality of second features 144b of the second input 126. In an embodiment, the second input 126 includes a video. The second task-specific AI model 138b performs pattern mining on the second input 126 to uncover patterns associated with the second input 126. For example, the patterns may include inconsistent facial expressions, inconsistent lip synchronizations, lack of natural interactions, unusual background or environment, inconsistent behaviors, repetitive behaviors, technical artifacts, or quality issues. Extracting the second features 144b from the second input 126 is based on the uncovered patterns.

At operation 212, backend system 130 extracts, by the generative AI model 136, a first subset of first features 146a from the plurality of first features 144a and a second subset of second features 146b from the plurality of second features 144b. The first subset of first features 146a are the most relevant features of the first modality. The second subset of second features 146b are the most relevant features of the second modality.

At operation 214, backend system 130 determines whether the multi-modal input 122 is associated with an interaction.

If the multi-modal input 122 is associated with an interaction, method 200 then proceeds to operation 216. At operation 216, backend system 130 executes a third task-specific AI model 138c to extract interaction metadata. For example, the interaction metadata may include one or more of a location associated with the interaction, an IP address associated with the interaction, a time associated with the interaction, or an interaction type. Method 200 then proceeds to operation 218.

If the multi-modal input 122 is not associated with an interaction, method 200 then proceeds to operation 218.

At operation 218, backend system 130 generates, by performing multi-modal fusion on the first subset of first features 146a, the second subset of second features 146b, and the interaction metadata (if any) by the generative AI model 136, a unified multi-modal feature representation 148 for the multi-modal input 122. The unified multi-modal feature representation 148 integrates the first subset of first features 146a, the second subset of second features 146b, and the interaction metadata (if any).

At operation 220, backend system 130 executes the generative AI model 136 on the unified multi-modal feature representation 148 to output an execution result 150 for the task 142. The execution result 150 may include decision made regarding the task 142 or a prediction associated with the task 142. For example, the execution result 150 may be the determination of whether a chat message, email, audio, or video is generated by an AI system or by an actual user. As another example, the execution result 150 may be whether an interaction is a prohibited interaction. In an embodiment, if the interaction is prohibited, backend system 130 may decline the interaction; if the interaction is not prohibited, backend system 130 may approve the interaction.

Through operation 204 to operation 220, in an embodiment, generative AI model 136 and task-specific AI models 138 may be executed by the same processors 132. In another embodiment, generative AI model 136 and task-specific AI models 138 may be executed by different processors 132. In another embodiment, among task-specific AI models 138, at least two of the task-specific AI model 138 may be executed by different processors 132. In yet another embodiment, generative AI model 136 and some of the task-specific AI models 138 may be executed by the same processors 132 while the other task-specific AI models 138 may be executed by other processors 132.

At operation 222, backend system 130 transmits the execution result 150 to the origin of the multi-modal input 122. For example, the original may be user device 112 or support system 120. In an embodiment, support system 120 may perform actions responsive to the received execution result 150. Continue with the previous example of whether an interaction is a prohibited interaction. If the interaction is prohibited, support system 120 may decline the interaction. If the interaction is not prohibited, support system 120 may approve the interaction.

At operation 224, backend system 130 receives feedback for the execution results 150.

At operation 226, backend system 130 determines whether the feedback indicates the execution results 150 meet performance criteria. For example, if the task 142 is detecting prohibited interactions, the performance criteria may include precision, recall, and F1-score. If the feedback indicates the execution results 150 meet performance criteria, method 200 then ends at operation 228.

If the feedback indicates the execution results 150 do not meet performance criteria, method 200 proceeds to operation 230.

At operation 230, backend system 130 retrains the generative AI model 136 and the plurality of task-specific AI models 138 based on the feedback. During the retraining, backend system 130 may perform model hyperparameter adjustment for generative AI model 136 and the task-specific AI models 138 based on their performance, in which iterative adjustments are made to the hyperparameters.

Method 200 then ends at operation 232.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “operation for” are explicitly used in the particular claim.

1. A system, comprising:
a memory operable to store:
a generative artificial-intelligence (AI) model; and
a plurality of task-specific AI models, wherein each of the task-specific AI models was trained to process inputs in a particular modality for a particular task; and
one or more processors, operably coupled to the memory, and configured to:
receive a multi-modal input combining a plurality of different types of data, wherein the multi-modal input comprises at least a first input in a first modality corresponding to a first type of data and a second input in a second modality corresponding to a second type of data;
execute the generative AI model on the multi-modal input to determine a task associated with the multi-modal input;
load, based at least in part upon the task and the multi-modal input by the generative AI model, a first task-specific AI model from the plurality of task-specific AI models to process the first input;
load, based at least in part upon the task and the multi-modal input by the generative AI model, a second task-specific AI model from the plurality of task-specific AI models to process the second input, wherein the first task-specific AI model is configured to process the first input and the second task-specific AI model is configured to process the second input independently of each other;
execute the first task-specific AI model on the first input to extract a plurality of first features of the first input;
execute the second task-specific AI model on the second input to extract a plurality of second features of the second input;
extract, by the generative AI model, a first subset of first features from the plurality of first features;
extract, by the generative AI model, a second subset of second features from the plurality of second features;
generate, based at least in part upon the first subset of first features and the second subset of second feature by the generative AI model, a unified multi-modal feature representation for the multi-modal input, wherein the unified multi-modal feature integrates the first subset of first features and the second subset of second features; and
execute the generative AI model on the unified multi-modal feature representation to output an execution result for the task.

2. The system of claim 1, wherein:
the generative AI model is executed by a first processor of the one or more processors;
the first task-specific AI model is executed by a second processor of the one or more processors;
the second task-specific AI model is executed by a third processor of the one or more processors; and
at least two of the first, second, and third processors are different processors.

3. The system of claim 1, wherein the generative AI model, the first task-specific AI model, and the second task-specific AI model are executed by one or more same processors of the one or more processors.

4. The system of claim 1, wherein:
the multi-modal input is associated with a first interaction;
the task comprises detecting whether the first interaction is a prohibited interaction; and
executing the generative AI model on the unified multi-modal feature representation to output the execution result for the task comprises:
executing the generative AI model on the unified multi-modal feature representation to output a probability score indicating a likelihood of the first interaction being a prohibited interaction;
declining the first interaction if the probability score is greater than a threshold score, wherein the execution result for the task comprises a declination of the first interaction; and
approving the first interaction if the probability score is not greater than the threshold score, wherein the execution result for the task comprises an approval of the first interaction.

5. The system of claim 4, whether the processors are further configured to:
execute a third task-specific AI model from the plurality of task-specific AI models to extract interaction metadata associated with the interaction, wherein the interaction metadata comprises one or more of a location associated with the first interaction, an IP address associated with the first interaction, a time associated with the first interaction, or a type associated with the first interaction; and
integrate the interaction metadata into the unified multi-modal feature representation for the multi-modal input.

6. The system of claim 1, wherein the first input comprises a text string or a speech, and wherein the processors are further configured to:
perform pattern mining on the first input using the first task-specific AI model to uncover one or more patterns comprising one or more of a language pattern, an inconsistency, a depth of understanding, a response timing, an error pattern, an interaction pattern, or a factual inaccuracy, wherein extracting the plurality of first features from the first input is based on the uncovered patterns.

7. The system of claim 1, wherein the second input comprises a video, and wherein the processors are further configured to:
perform pattern mining on the second input using the second task-specific AI model to uncover one or more patterns comprising one or more of an inconsistent facial expression, an inconsistent lip sync, a lack of natural interaction, an unusual background or environment, an inconsistent behavior, a repetitive behavior, a technical artifact, or a quality issue, wherein extracting the plurality of second features from the second input is based on the uncovered patterns.

8. A method comprising, by one or more processors:
receiving a multi-modal input combining a plurality of different types of data, wherein the multi-modal input comprises at least a first input in a first modality corresponding to a first type of data and a second input in a second modality corresponding to a second type of data;
executing a generative AI model on the multi-modal input to determine a task associated with the multi-modal input;
loading, based at least in part upon the task and the multi-modal input by the generative AI model, a first task-specific AI model from a plurality of task-specific AI models to process the first input;
loading, based at least in part upon the task and the multi-modal input by the generative AI model, a second task-specific AI model from the plurality of task-specific AI models to process the second input, wherein the first task-specific AI model is configured to process the first input and the second task-specific AI model is configured to process the second input independently of each other;
executing the first task-specific AI model on the first input to extract a plurality of first features of the first input;
executing the second task-specific AI model on the second input to extract a plurality of second features of the second input;
extracting, by the generative AI model, a first subset of first features from the plurality of first features;
extracting, by the generative AI model, a second subset of second features from the plurality of second features;
generating, based at least in part upon the first subset of first features and the second subset of second feature by the generative AI model, a unified multi-modal feature representation for the multi-modal input, wherein the unified multi-modal feature integrates the first subset of first features and the second subset of second features; and
executing the generative AI model on the unified multi-modal feature representation to output an execution result for the task.

9. The method of claim 8, wherein:
the generative AI model is executed by a first processor of the one or more processors;
the first task-specific AI model is executed by a second processor of the one or more processors;
the second task-specific AI model is executed by a third processor of the one or more processors; and
at least two of the first, second, and third processors are different processors.

10. The method of claim 8, wherein the generative AI model, the first task-specific AI model, and the second task-specific AI model are executed by one or more same processors of the one or more processors.

11. The method of claim 8, wherein:
the multi-modal input is associated with a first interaction;
the task comprises detecting whether the first interaction is a prohibited interaction; and
executing the generative AI model on the unified multi-modal feature representation to output the execution result for the task comprises:
executing the generative AI model on the unified multi-modal feature representation to output a probability score indicating a likelihood of the first interaction being a prohibited interaction;
declining the first interaction if the probability score is greater than a threshold score, wherein the execution result for the task comprises a declination of the first interaction; and
approving the first interaction if the probability score is not greater than the threshold score, wherein the execution result for the task comprises an approval of the first interaction.

12. The method of claim 11, further comprising:
executing a third task-specific AI model from the plurality of task-specific AI models to extract interaction metadata associated with the interaction, wherein the interaction metadata comprises one or more of a location associated with the first interaction, an IP address associated with the first interaction, a time associated with the first interaction, or a type associated with the first interaction; and
integrating the interaction metadata into the unified multi-modal feature representation for the multi-modal input.

13. The method of claim 8, wherein the first input comprises a text string or a speech, and wherein the method further comprises:
performing pattern mining on the first input using the first task-specific AI model to uncover one or more patterns comprising one or more of a language pattern, an inconsistency, a depth of understanding, a response timing, an error pattern, an interaction pattern, or a factual inaccuracy, wherein extracting the plurality of first features from the first input is based on the uncovered patterns.

14. The method of claim 8, wherein the second input comprises a video, and wherein the method further comprises:
perform pattern mining on the second input using the second task-specific AI model to uncover one or more patterns comprising one or more of an inconsistent facial expression, an inconsistent lip sync, a lack of natural interaction, an unusual background or environment, an inconsistent behavior, a repetitive behavior, a technical artifact, or a quality issue, wherein extracting the plurality of second features from the second input is based on the uncovered patterns.

15. A non-transitory computer-readable medium storing instructions that, when executed by one or more processors of a system, cause the one or more processors to:
receive a multi-modal input combining a plurality of different types of data, wherein the multi-modal input comprises at least a first input in a first modality corresponding to a first type of data and a second input in a second modality corresponding to a second type of data;
execute a generative AI model on the multi-modal input to determine a task associated with the multi-modal input;
load, based at least in part upon the task and the multi-modal input by the generative AI model, a first task-specific AI model from a plurality of task-specific AI models to process the first input;
load, based at least in part upon the task and the multi-modal input by the generative AI model, a second task-specific AI model from the plurality of task-specific AI models to process the second input, wherein the first task-specific AI model is configured to process the first input and the second task-specific AI model is configured to process the second input independently of each other;
execute the first task-specific AI model on the first input to extract a plurality of first features of the first input;
execute the second task-specific AI model on the second input to extract a plurality of second features of the second input;
extract, by the generative AI model, a first subset of first features from the plurality of first features;
extract, by the generative AI model, a second subset of second features from the plurality of second features;
generate, based at least in part upon the first subset of first features and the second subset of second features by the generative AI model, a unified multi-modal feature representation for the multi-modal input, wherein the unified multi-modal feature integrates the first subset of first features and the second subset of second features; and
execute the generative AI model on the unified multi-modal feature representation to output an execution result for the task.

16. The non-transitory computer-readable medium of claim 15, wherein:
the generative AI model is executed by a first processor of the one or more processors;
the first task-specific AI model is executed by a second processor of the one or more processors;
the second task-specific AI model is executed by a third processor of the one or more processors; and
at least two of the first, second, and third processors are different processors.

17. The non-transitory computer-readable medium of claim 15, wherein the generative AI model, the first task-specific AI model, and the second task-specific AI model are executed by one or more same processors of the one or more processors.

18. The non-transitory computer-readable medium of claim 15, wherein:
the multi-modal input is associated with a first interaction;
the task comprises detecting whether the first interaction is a prohibited interaction; and
executing the generative AI model on the unified multi-modal feature representation to output the execution result for the task comprises:
executing the generative AI model on the unified multi-modal feature representation to output a probability score indicating a likelihood of the first interaction being a prohibited interaction;
declining the first interaction if the probability score is greater than a threshold score, wherein the execution result for the task comprises a declination of the first interaction; and
approving the first interaction if the probability score is not greater than the threshold score, wherein the execution result for the task comprises an approval of the first interaction.

19. The non-transitory computer-readable medium of claim 18, wherein the instructions further cause the one or more processors to:
execute a third task-specific AI model from the plurality of task-specific AI models to extract interaction metadata associated with the interaction, wherein the interaction metadata comprises one or more of a location associated with the first interaction, an IP address associated with the first interaction, a time associated with the first interaction, or a type associated with the first interaction; and
integrate the interaction metadata into the unified multi-modal feature representation for the multi-modal input.

20. The non-transitory computer-readable medium of claim 15, wherein the first input comprises a text string or a speech, and wherein the instructions further cause the one or more processors to:
perform pattern mining on the first input using the first task-specific AI model to uncover one or more patterns comprising one or more of a language pattern, an inconsistency, a depth of understanding, a response timing, an error pattern, an interaction pattern, or a factual inaccuracy, wherein extracting the plurality of first features from the first input is based on the uncovered patterns.
